(19) United States
(12) Patent Application Publication
(10) Pub. No.: US 2022/0099114 A1
(43) Pub. Date: Mar. 31, 2022

(54) FLOW CONDITIONING DEVICE HAVING INTEGRATED FLOW CONDITIONING ELEMENTS

(71) Applicant: GM GLOBAL TECHNOLOGY OPERATIONS LLC, Detroit, MI (US)

(72) Inventors: Jeffrey Harris, Detroit, MI (US); Andrew T. Cunningham, Royal Oak, MI (US); Zachary P. Steffes, West Bloomfield, MI (US); Thomas Curtis, Royal Oak, MI (US); Qigui Wang, Rochester Hills, MI (US); David C. Caples, Huntington Woods, MI (US)

(73) Assignee: GM GLOBAL TECHNOLOGY OPERATIONS LLC, Detroit, MI (US)

(21) Appl. No.: 17/038,501

(22) Filed: Sep. 30, 2020

(51) Int. Cl. F15D 1/04

(52) U.S. Cl. CPC F15D 1/04; B33Y 80/00

(57) ABSTRACT

A flow conditioning device includes a body portion having first and second ends and an interior surface defining a channel extending from the first end to the second end, and one or more flow conditioning elements disposed within the channel. Each of the one or more flow conditioning elements is integrally formed with the interior surface of the body portion, and may be a respective flow straightening tube, a flow straightening vane, a hole array plate, a turning vane, a swirling vane, a helical ridge formed along a respective longitudinal segment of the interior surface, or another configuration. The body portion and the one or more flow conditioning elements may be formed by an additive manufacturing process, and may optionally be made of the same material.

### INTRODUCTION

This disclosure relates to flow conditioning devices having integrated flow conditioning elements.

“Flow conditioning” refers to the use of specialized hardware within a duct to alter one or more flow properties of a fluid flowing within the duct. This fluid may be a liquid or gas, and the duct may be any type of closed-channel conduit, such as a pipe, duct, manifold, tube or the like. The flow properties affected by the aforementioned flow conditioning hardware may include flow velocity (i.e., flow speed and direction), laminar vs. turbulent flow, vorticity, swirl, etc.

While it is known to use certain hardware such as hole array plates, straightening vanes and turning vanes in the fluid flow path within ducts, the customary approach is to manufacture ducts and flow conditioning hardware as separate components, and to install the flow conditioning hardware in the ducts only as and where needed. This is because of the complex geometry of the hole arrays or vanes, making it difficult or impossible to manufacture the duct and the flow conditioning hardware together, such as by injection molding or extrusion. Instead, the customary approach for utilizing such flow conditioning hardware is to manufacture the hole arrays or vanes as part of a separate plate or very short tube section which carries the holes or vanes, and then to install such plates or short tube sections where needed in the flow path.

However, the potential exists for misalignments and leaks between the ducts and the plates or tube sections that carry the flow conditioning hardware. Also, there is cost in terms of parts and labor associated with assembling these components together (along with gaskets, fasteners, etc.), as well as costs (including downtime) associated with repairs when the components are misaligned and leaking.

### SUMMARY

According to one embodiment, a flow conditioning device includes a body portion having first and second ends and an interior surface defining a channel extending from the first end to the second end, and one or more flow conditioning elements disposed within the channel, wherein each of the one or more flow conditioning elements is integrally formed with the interior surface of the body portion. The body portion and the one or more flow conditioning elements may be formed of the same material, and may be formed by an additive manufacturing process. For example, material may be added in thin layers, layer by layer, to create the unique shape of the body portion having the unique flow conditioning element(s) and/or channel(s). The flow conditioning device may further include a sensor embedded at a position within the body portion and/or within at least one of the one or more flow conditioning elements, wherein the sensor is placed at the position during the additive manufacturing process.

The channel may have a non-straight centerline and may be configured for confined passage of a fluid therethrough. Each of the one or more flow conditioning elements may be a respective flow straightening tube, a flow straightening vane, a hole array plate, a turning vane, a swirling vane or a helical ridge formed along a respective longitudinal segment of the interior surface. The channel may have a bend therein and each of the one or more flow conditioning elements may be disposed proximate the bend in the form of a respective turning vane.

The body portion may have a generally tubular shape, and the generally tubular shape may be substantially non-straight. The flow conditioning device may be configured as one of an air delivery system, an HVAC duct, a brake cooling duct, a coolant hose, a mass airflow sensor, an exhaust duct, a muffler, and an oil line.

The channel may define a main inlet at the first end and a main outlet at the second end, with the interior surface further defining an auxiliary channel within the body portion. The auxiliary channel may have an auxiliary inlet at one end thereof separate from the main inlet and a mixing port at another end thereof, wherein the mixing port may be disposed in fluid communication with the channel at a location flow-wise between the main inlet and the main outlet.

According to another embodiment, a flow conditioning device includes: a body portion having first and second ends and an interior surface defining a channel extending from the first end to the second end; and one or more flow conditioning elements disposed within the channel and being integrally formed with the interior surface, wherein each of the one or more flow conditioning elements is a respective flow straightening tube, a flow straightening vane, a hole array plate, a turning vane, a swirling vane or a helical ridge formed along a respective longitudinal segment of the interior surface. In this embodiment, the body portion and the one or more flow conditioning elements are formed by an additive manufacturing process.

The body portion and the one or more flow conditioning elements may be formed of the same material. The channel may have a bend therein and each of the one or more flow conditioning elements may be disposed proximate the bend in the form of a respective turning vane. The body portion may have a generally non-straight tubular shape, wherein the channel may have a non-straight centerline. The channel may define a main inlet at the first end and a main outlet at the second end, with the interior surface further defining an auxiliary channel within the body portion; in this configuration, the auxiliary channel may have an auxiliary inlet at one end thereof separate from the main inlet and a mixing port at another end thereof, wherein the mixing port is disposed in fluid communication with the channel at a location flow-wise between the main inlet and the main outlet.

According to yet another embodiment, a flow conditioning apparatus for confined passage of a fluid therethrough includes: (i) a body portion having first and second ends and an interior surface defining a channel extending from the first end to the second end; (ii) one or more flow conditioning elements disposed within the channel and being integrally formed with the interior surface, wherein each of the one or more flow conditioning elements is a respective flow straightening tube, a flow straightening vane, a hole array plate, a turning vane, a swirling vane or a helical ridge formed along a respective longitudinal segment of the interior surface; and (iii) wherein the body portion and the one or more flow conditioning elements are formed of the same material by an additive manufacturing process.

In this embodiment, the channel may have a bend therein and each of the one or more flow conditioning elements may be disposed proximate the bend in the form of a respective turning vane. The channel may define a main inlet at the first end and a main outlet at the second end, with the interior surface further defining an auxiliary channel within the body portion. The auxiliary channel may have an auxiliary inlet at one end thereof separate from the main inlet and a mixing port at another end thereof, wherein the mixing port is disposed in fluid communication with the channel at a location flow-wise between the main inlet and the main outlet.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic cross-sectional view of a flow conditioning device having an integrated helical ridge formed along an interior surface.

FIG. 2 is a schematic end view along line 2-2 of FIG. 1.

FIG. 3 is a schematic cross-sectional view along line 3-3 of FIG. 1.

FIG. 4 is a schematic cross-sectional view along line 4-4 of FIG. 1.

FIG. 5 is a schematic perspective view of a flow conditioning device having a curved body portion and a plurality of integrated flow straightening tubes therein.

FIG. 6 is a schematic perspective view of a flow conditioning device having a body portion with two bends or elbows and a plurality of integrated turning vanes therein.

FIG. 7 is a schematic cross-sectional view along line 7-7 of FIG. 6.

FIG. 8 is a schematic cross-sectional view of a flow conditioning device having an inlet manifold and a straight section, with an integrated hole array plate and a plurality of integrated flow straightening vanes in the straight section.

FIG. 9 is a schematic cross-sectional view along line 9-9 of FIG. 8.

FIG. 10 is a schematic cross-sectional view along line 10-10 of FIG. 8.

FIG. 11 is a schematic view of an ordinary flow conditioning arrangement.

FIG. 12 is a schematic view of a flow conditioning arrangement in accordance with the present disclosure, including a plurality of integrated turning vanes.

FIG. 13 is a schematic cross-sectional view of a flow conditioning device having a main channel and an auxiliary channel for mixing fluids.

FIG. 14 is a schematic view of another ordinary flow conditioning arrangement.

FIG. 15 is a schematic cross-sectional view along line 15-15 of FIG. 14, illustrating Dean flow vortices.

FIG. 16 is a schematic cross-sectional view of a flow conditioning arrangement in accordance with the present disclosure, including a plurality of integrated flow conditioning elements for the mitigation of Dean flow vortices.

FIG. 17 illustrates a collection of flow conditioning element types.

FIG. 18 illustrates a collection of flow conditioning device configurations.

### DETAILED DESCRIPTION

Referring now to the drawings, wherein like numerals indicate like parts in the several views, various configurations of a flow conditioning device or apparatus 20, including one or more integrated flow conditioning elements (FCE) 50, are shown and described herein. Note that certain reference numerals in the drawings have subscripts, such as integrated FCEs 50_{FST}, 50_{TV}, 50_{HR} and the like. Subscripts are used in the drawings and in the present description to refer to individual elements or types of elements, while the use of reference numerals without subscripts may refer to the collective group of all such elements and/or to a singular but generic one of such elements. Thus, reference numeral 50_{FST} (with the subscript) refers to a specific integrated FCE or a specific type of integrated FCE, while reference numeral 50 (without the subscript) may refer to all the FCEs, the group of FCEs, or a singular but generic FCE (i.e., any FCE).

The flow conditioning device 20 as disclosed herein provides the advantage of having the duct or body portion 22 and the FCEs 50 integrated as a single unit, such as by additive manufacturing (e.g., 3D printing). This integration avoids the abovementioned issues (and costs) associated with potential misalignments, leaks, assembly and repairs.

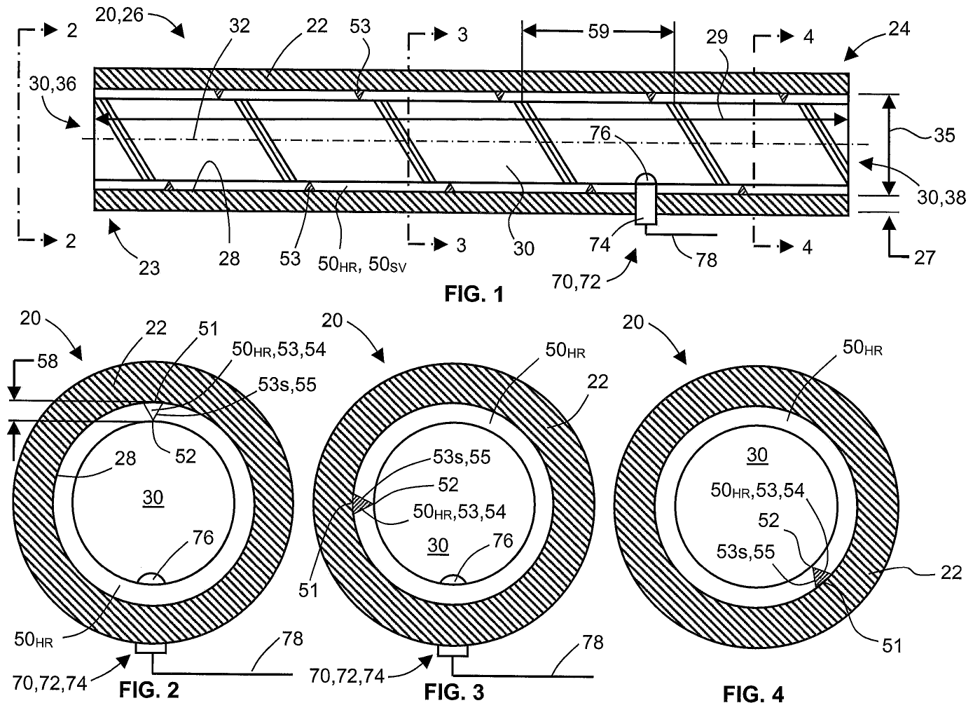

FIG. 1 shows a schematic cross-sectional view of a flow conditioning device 20 having an integrated helical ridge 50_{HR} formed along a longitudinal interior surface 28. This configuration includes a body portion 22 having opposed first and second ends 23, 24 and an interior surface 28 defining a channel 30 extending from the first end 23 to the second end 24. The channel 30 has a diameter 35 and the body portion 22 has a wall thickness 27. The diameter 35 and wall thickness 27 may be generally constant along some or all of the respective lengths of the channel 30 and body portion 22 (as illustrated in FIG. 1), or they may vary along either or both of these lengths. The configuration also includes one or more FCEs 50 disposed within the channel 30, wherein each of the one or more FCEs 50 is integrally formed with the interior surface 28 of the body portion 22. As used herein, the FCEs 50 being “integrated” or “integrally formed” with the interior surface 28 of the body portion 22 means that the FCEs 50 and body portion 22 may be formed together or simultaneously, such as by using the same manufacturing process. This means there is no need for the body portion 22 and FCEs 50 to be manufactured separately from each other, nor do they need to be assembled together as separate parts. For example, the body portion 22 and FCEs 50 may be produced by an additive manufacturing process, such as 3D printing, thereby allowing these components 22, 50 to be manufactured at the same time and by using the same manufacturing process. The body portion 22 and the one or more FCEs 50 may be formed of the same material, such as a thermoplastic or thermoset material. Alternatively, two different materials may be used (i.e., one material for the body portion 22 and another material for the one or more FCEs 50), but the use of two or more different materials may easily be accommodated using certain additive manufacturing equipment.

The flow conditioning device 20 may further include a sensor 70 embedded at a position 72 within the body portion 22 (e.g., somewhere between the first and second ends 23, 24), and/or embedded within at least one of the one or more FCEs 50. The sensor 70 has a housing portion 74 that is embedded within the body portion 22 and/or within one or more FCEs 50, and a sensing portion 76 which extends into the channel 30 so that it may sense the flow of fluid 19 therein. A wire 78 may extend from the housing portion 74 for carrying a data signal indicative of the sensed condition of the fluid 19, or the sensor 70 may be wireless. A hole (not shown) may be drilled or cut through the body portion 22 so that the sensor 70 may be operatively inserted therein, or the sensor 70 may be placed at the position 72 (e.g., a predetermined position) during the additive manufacturing process.

The configuration of a flow conditioning device 20 illustrated in FIG. 1 includes a body portion 22 configured as a straight pipe having a generally tubular shape 26. The device 20 also has an FCE 50 in the form of a helical or spiral ridge 50_{HR} formed along a respective longitudinal segment 29 of the body portion's interior surface 28. The body portion 22 may assume other shapes besides being generally tubular, and a generally tubular shape 26 may either be generally straight (as shown in FIG. 1) or substantially non-straight (as illustrated in some of the other drawings discussed below).

FIG. 2 is a schematic end view along line 2-2 of FIG. 1, and FIGS. 3-4 are schematic cross-sectional views along lines 3-3 and 4-4, respectively, of FIG. 1. In these views, an FCE 50 shaped as a helical ridge 50_{HR} is shown, which appears as an annulus in these views. Here, the helical ridge 50_{HR} has a triangular cross-sectional profile 53, a root portion 51 integral with and extending from the body portion 22, a distal portion 52 on the opposite side of the profile 53 from the root portion 51, and a main body 54 extending for a height 58 from the root portion 51 to the distal portion 52. (Note that as used here, the profile 53 refers to the cross-sectional area of the FCE 50 and/or to the perimeter of this cross-sectional area.) One or both of the sides 53s of the helical ridge 50_{HR} may serve as a control surface 55 configured to facilitate a flow conditioning effect, such as encouraging (or mitigating) vorticity, swirl, flow redirection, etc. While FIGS. 1-4 show a single FCE 50 configured as a helical ridge 50_{HR}, each flow conditioning device 20 may use one or more FCEs 50 which may assume a variety of shapes and sizes and provide a variety of flow conditioning effects. Note that each FCE 50 may have its own unique combination of profile 53, root portion 51, distal portion 52, control surfaces 55, height 58 and the like.

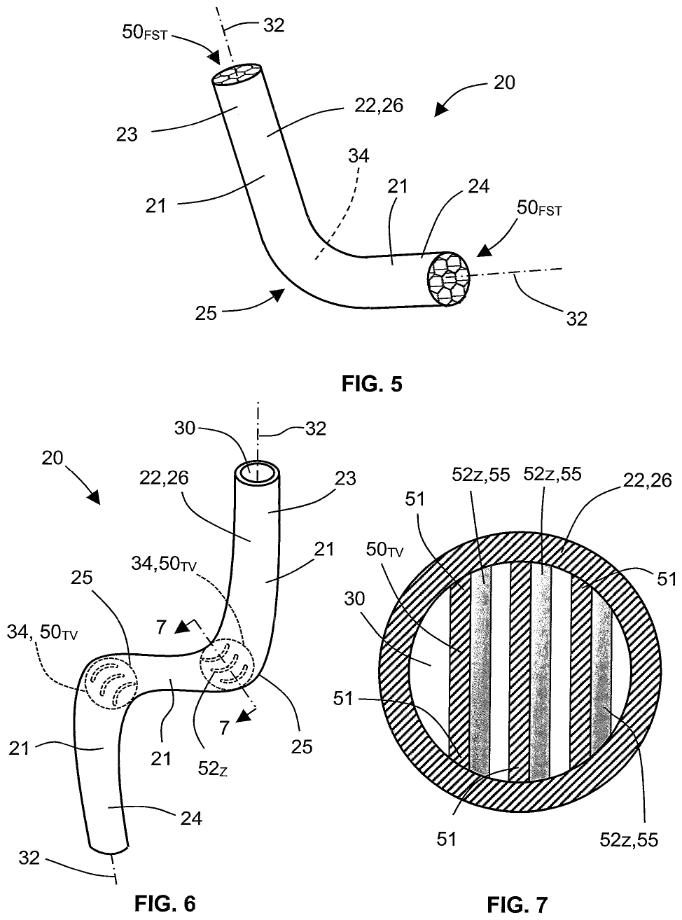

The channel 30 running through the body portion 22 may be straight and have a straight centerline 32 as shown in FIG. 1, or it may be curved and have a curved or non-straight centerline 32 such as illustrated by the curved body portions 22 shown in FIGS. 5 and 6. In either case, the channel 30, body portion 22 and flow conditioning device or apparatus 20 may be configured for confined passage (i.e., closed-channel flow) of a fluid 19 therethrough, such as from the first end 23 to the second end 24. In the device 20 illustrated in FIG. 5, the body portion 22 has a single elbow or bend 25 between two generally straight portions 21, and a plurality of FCEs 50 configured as flow straightening tubes 50_{FST}, arrayed as a honeycomb-shaped collection of hexagonal tubes. In the device 20 illustrated in FIG. 6, the body portion 22 has two elbows or bends 25 and three straight portions 21, and a set of FCEs 50 configured as turning vanes 50_{TV} disposed within the channel 30 at each bend 34 therein (i.e., within each elbow 25). FIG. 7 shows a schematic cross-sectional view along line 7-7 of FIG. 6, which is located at one of the elbows 25. Each of the turning vanes 50_{TV} includes an upper and lower root portion 51 where the turning vane 50_{TV} is attached to the interior surface 28 of the body portion 22, and a portion 52z which extends away (e.g., downstream) from the cross-hatched portion. The surface of this portion 52z, as well as the surfaces of other portions of the turning vanes 50_{TV}, may serve as control surfaces 55 for altering the flow direction of the fluid 19.

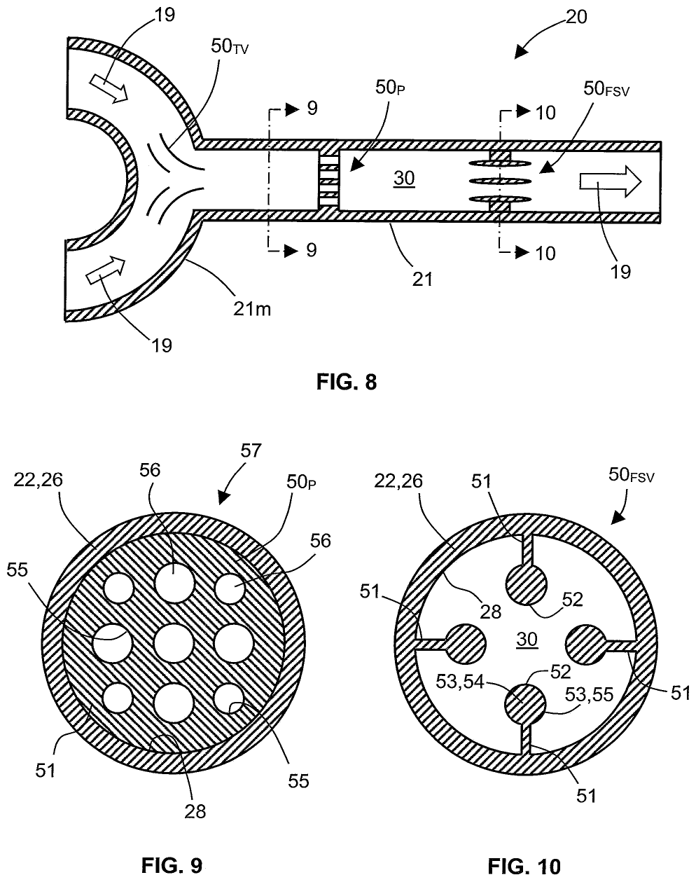

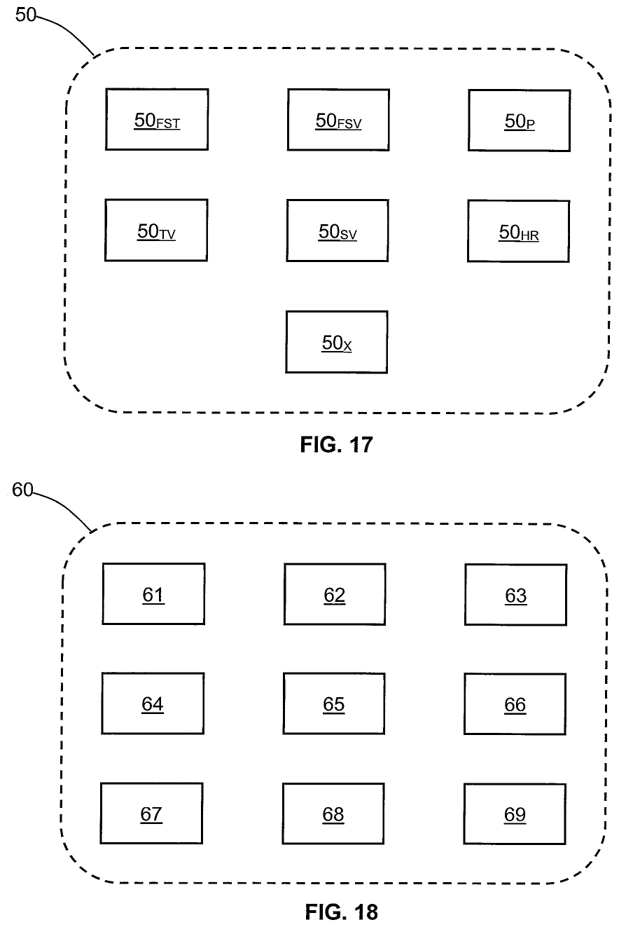

As illustrated in FIG. 17, each of the one or more FCEs 50 may be a respective flow straightening tube 50_{FST} (FIG. 5), a flow straightening vane 50_{FSV} (FIGS. 8 and 10), a hole array plate 50_{P}(FIGS. 8-9) a turning vane 50_{TV}, (FIGS. 6-8 and 12), a swirling vane 50_{SV} (FIG. 1), a helical ridge 50_{HR} formed along a respective longitudinal segment 29 of the interior surface 28 (FIGS. 1-4), and/or another configuration 50_{X} of FCE 50. Note that the helical ridge 50_{HR} of FIG. 1 may also serve as a swirling vane 50_{SV} (having a helical pitch 59, as shown in FIG. 1), since it may impart a swirling effect upon fluid 19 flowing through the channel 30.

FIG. 8 shows a flow conditioning device 20 whose body portion 22 has a straight portion 21 and a manifold portion 21m. A set of turning vanes 50_{TV} is disposed at the junction between the manifold 21m and the straight portion 21. FIGS. 9 and 10 show schematic cross-sectional views at lines 9-9 and 10-10, respectively. In FIG. 9, a hole array plate 50_{P} is shown, which has a circumferential root portion 51 that is integral with the interior surface 28 of the body portion 22. The hole array plate 50_{P} includes a plurality of holes 56 formed therethrough, with the holes 56 arranged in an array 57. The diameters of the holes 56 and the arrangement of the holes 56 within the array 57 may be optimized for particular fluids so as to urge a desired state of flow (such as laminar flow). In FIG. 10, a collection of flow straightening vanes 50_{FSV} is shown. These flow straightening vanes 50_{FSV} may be generally torpedo-shaped as shown here, or they may assume other shapes configured to induce a flow straightening effect upon a fluid 19 flowing in the channel 30. Each of the flow straightening vanes 50_{FSV} has a root portion 51 that is integral with the interior surface 28 of the body portion 22, and a distal portion 52 opposed from the root portion 51. Each flow straightening vane 50_{FSV} has a profile 53 (shown as being circular here), a main body 54 between the root portion 51 and the distal portion 52, and a control surface 55 defined by at least the main body 54 for urging a flow straightening effect.

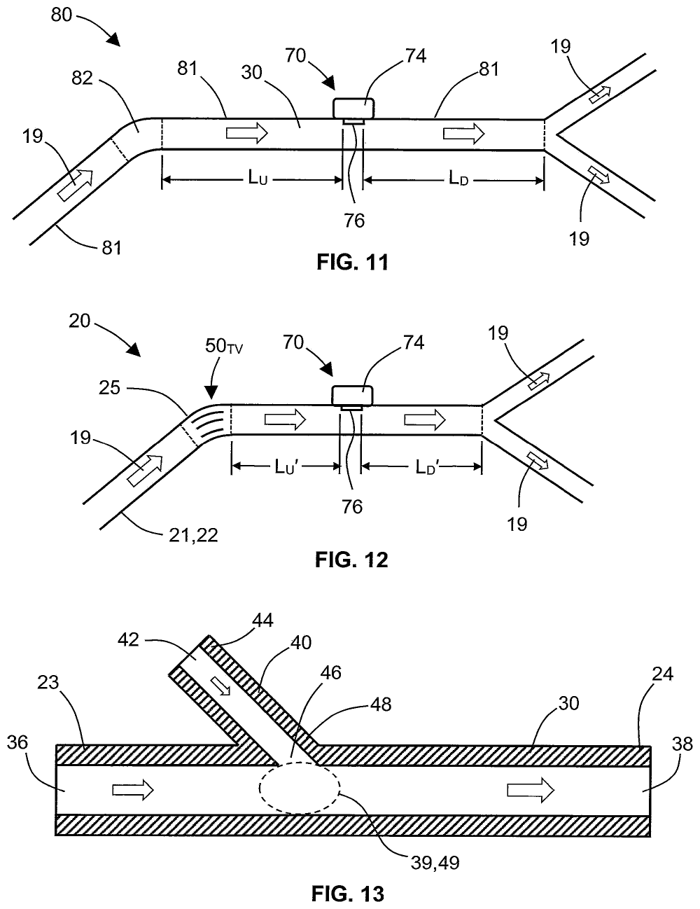

FIG. 11 shows a schematic view of an ordinary flow conditioning arrangement, and FIG. 12 illustrates a schematic view of a flow conditioning arrangement in accordance with the present disclosure, including a plurality of integrated turning vanes 50_{TV}, which is an improvement upon the arrangement shown in FIG. 11. In the ordinary arrangement of FIG. 11, a sensor 70 having a housing portion 74 and a sensing portion 76 are engaged with a conventional duct 80 in which a fluid flow 19 is indicated. Upstream of the sensor 70 is an upward-extending straight portion 81, then an elbow or bend region 82, and then another straight portion 81. Downstream of the sensor 70 is a straight portion 81 and a “Y” section where the flow 19 splits into two channels. In this ordinary arrangement, a minimum upstream length L_{U} must be provided in which laminar or other stabilized flow is maintained, as well as a minimum downstream length L_{D} in which laminar or other stabilized flow must also be maintained. (These minimum lengths L_{U}, L_{D} are required for optimal operation of the sensor 70.) However, by the inclusion of turning vanes 50_{TV} in the elbow region 25 as illustrated in FIG. 12, the minimum upstream and downstream lengths may be shortened (i.e., L_{U′} and L_{D′}, respectively), thus enabling the overall flow conditioning device 20 to be shorter in length than that of the ordinary arrangement 80. Here, L_{U′} is shorter than L_{U}, and L_{D′} is shorter than L_{D}.

In each of the configurations shown (see, for example, FIG. 1), the channel 30 may define a main inlet 36 at the first end 23 of the body portion 22, and a main outlet 38 at the second end 24 of the body portion 22. As illustrated in FIG. 13, the interior surface 26 may further define an auxiliary channel 40 within the body portion 22. The auxiliary channel 40 may have an auxiliary inlet 42 at one end 44 thereof which is separate from the main inlet 36, and an auxiliary outlet or mixing port 46 at another end thereof 48, wherein the mixing port 46 may be disposed in fluid communication with the channel 30 at a location 39 that is located flow-wise between the main inlet 36 and the main outlet 38. A mixing region 49 is defined at the volumetric space where the auxiliary channel 40 meets the main channel 30 (i.e., proximate the auxiliary outlet/mixing port 46, and within the main channel 30). A fluid 19 flowing through the auxiliary channel 40 may be mixed at the mixing region 49 with another fluid 19 flowing through the main channel 30.

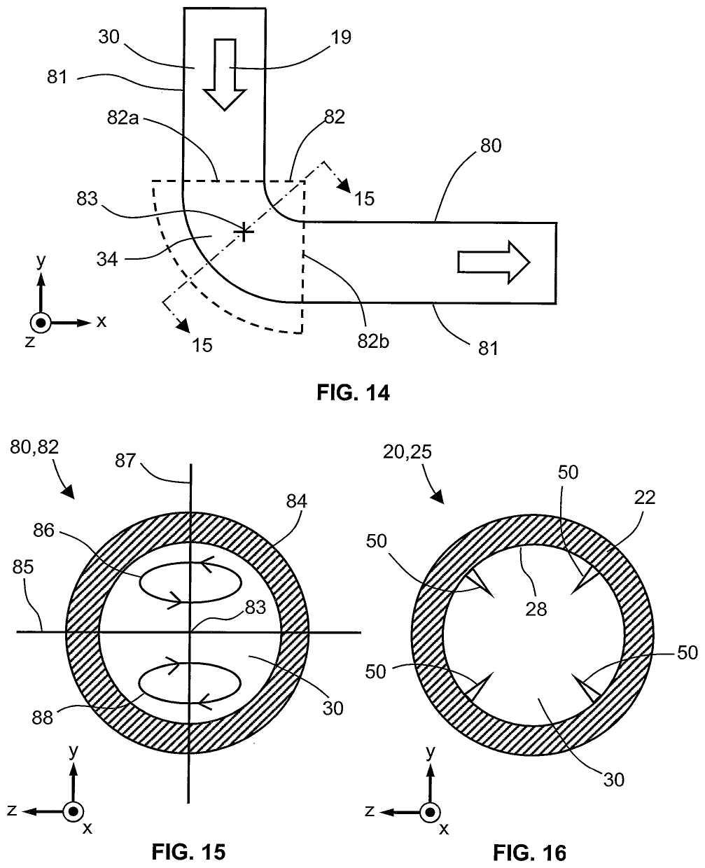

FIG. 14 shows a schematic view of another ordinary flow conditioning arrangement, along with an arbitrarily defined set of x, y and z axes and an assumed direction of fluid flow 19. In this arrangement, a conventional duct 80 has a 90-degree elbow or bend region 82 connecting one straight portion 81 at an upstream edge 82a of the region 82 and another straight portion 81 at a downstream edge 82b. The first straight portion 81 extends flow-wise in the negative y direction, and the second straight portion 81 extends flow-wise in the positive x direction. FIG. 15 shows a schematic cross-sectional view along line 15-15 of FIG. 14, which passes through a volumetric center 83 of the elbow or bend region 82. (In FIG. 15, axis 85 passes through the volumetric center 83 and extends in the z direction, while axis 87 also passes through the volumetric center 83 but extends at a 45-degree angle from both the x and y axes within the x-y plane.) It is known that at such bend regions 82, Dean flow vortices 86, 88 may occur due to a change in the flow direction 19 of the channel 30, causing the flow 19 to experience localized centripetal accelerations within the cross-section 84 at the bend region 82. This creates an adverse pressure gradient perpendicular to the local flow direction 19. However, as illustrated in FIG. 16, FCEs 50 that are integral with the interior surface 28 of the body portion 22 and which extend into the channel 30 may be used to mitigate Dean flow vortices 86, 88.

As illustrated in FIG. 18, the flow conditioning device or apparatus 20 may be configured in one or more of multiple possible configurations 60, such as an air delivery system 61, an HVAC (i.e., heating ventilation and air conditioning) duct 62, a brake cooling duct 63, a coolant hose 64, a mass airflow sensor 65, an exhaust duct 66, a muffler 67, an oil line 68 or one or more other suitable configurations 69.

According to another embodiment, a flow conditioning device 20 includes: a body portion 22 having first and second ends 23, 24 and an interior surface 28 defining a channel 30 extending from the first end 23 to the second end 24; and one or more FCEs 50 disposed within the channel 30 and being integrally formed with the interior surface 28, wherein each of the one or more FCEs 50 is a respective flow straightening tube 50_{FST}, a flow straightening vane 50_{FSV}, a hole array plate 50_{P}, a turning vane 50_{TV}, a swirling vane 50_{SV} or a helical ridge 50_{HR} formed along a respective longitudinal segment 29 of the interior surface 28. In this embodiment, the body portion 22 and the one or more FCEs 50 are formed by an additive manufacturing process, and may be formed of the same material.

In this other embodiment, the channel 30 may have a bend 34 therein and each of the one or more FCEs 50 may be disposed proximate the bend 34 in the form of a respective turning vane 50_{TV}. The body portion 22 may have a generally non-straight tubular shape 26, and the channel 30 may have a non-straight centerline 32. The channel 30 may define a main inlet 36 at the first end 23 and a main outlet 38 at the second end 24, with the interior surface 26 further defining an auxiliary channel 40 within the body portion 22. In this configuration, the auxiliary channel 40 may have an auxiliary inlet 42 at one end 44 thereof separate from the main inlet 36 and a mixing port 46 at another end 48 thereof, wherein the mixing port 46 is disposed in fluid communication with the channel 30 at a location 39 flow-wise between the main inlet 36 and the main outlet 38.

According to yet another embodiment, a flow conditioning apparatus 20 for confined passage of a fluid 19 therethrough includes: (i) a body portion 22 having first and second ends 23, 24 and an interior surface 28 defining a channel 30 extending from the first end 23 to the second end 24; (ii) one or more FCEs 50 disposed within the channel 30 and being integrally formed with the interior surface 28, wherein each of the one or more FCEs 50 is a respective flow straightening tube 50_{FST}, a flow straightening vane 50_{FSV}, a hole array plate 50_{P}, a turning vane 50_{TV}, a swirling vane 50_{SV} or a helical ridge 50_{HR} formed along a respective longitudinal segment 29 of the interior surface 28; and (iii) wherein the body portion 22 and the one or more FCEs 50 are formed of the same material by an additive manufacturing process.

In this further embodiment, the channel 30 may have a bend 34 therein and each of the one or more FCEs 50 may be disposed proximate the bend 34 in the form of a respective turning vane 50_{TV}. The channel 30 may define a main inlet 36 at the first end 23 and a main outlet 38 at the second end 24, with the interior surface 28 further defining an auxiliary channel 40 within the body portion 22. The auxiliary channel 40 may have an auxiliary inlet 42 at one end 44 thereof separate from the main inlet 36 and a mixing port 46 at another end 48 thereof, wherein the mixing port 46 is disposed in fluid communication with the channel 30 at a location 39 flow-wise between the main inlet 36 and the main outlet 38.

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “for the most part”, “to a significant extent” and/or “to a large degree”, and do not necessarily mean “perfectly”, “completely”, “strictly” or “entirely”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A flow conditioning device, comprising:
a body portion having first and second ends and an interior surface defining a channel extending from the first end to the second end; and
one or more flow conditioning elements disposed within the channel, wherein each of the one or more flow conditioning elements is integrally formed with the interior surface of the body portion.

2. The flow conditioning device of claim 1, wherein the body portion and the one or more flow conditioning elements are formed of the same material.

3. The flow conditioning device of claim 1, wherein the body portion and the one or more flow conditioning elements are formed by an additive manufacturing process.

4. The flow conditioning device of claim 3, further comprising a sensor embedded at a position within the body portion and/or within at least one of the one or more flow conditioning elements, wherein the sensor is placed at the position during the additive manufacturing process.

5. The flow conditioning device of claim 1, wherein the channel has a non-straight centerline.

6. The flow conditioning device of claim 1, wherein the channel is configured for confined passage of a fluid therethrough.

7. The flow conditioning device of claim 1, wherein each of the one or more flow conditioning elements is a respective flow straightening tube, a flow straightening vane, a hole array plate, a turning vane, a swirling vane or a helical ridge formed along a respective longitudinal segment of the interior surface.

8. The flow conditioning device of claim 1, wherein the channel has a bend therein and each of the one or more flow conditioning elements is disposed proximate the bend in the form of a respective turning vane.

9. The flow conditioning device of claim 1, wherein the flow conditioning device is configured as one of an air delivery system, an HVAC duct, a brake cooling duct, a coolant hose, a mass airflow sensor, an exhaust duct, a muffler, and an oil line.

10. The flow conditioning device of claim 1, wherein the body portion has a generally tubular shape.

11. The flow conditioning device of claim 10, wherein the generally tubular shape is substantially non-straight.

12. The flow conditioning device of claim 1, wherein the channel defines a main inlet at the first end and a main outlet at the second end, the interior surface further defining an auxiliary channel within the body portion, the auxiliary channel having an auxiliary inlet at one end thereof separate from the main inlet and a mixing port at another end thereof, wherein the mixing port is disposed in fluid communication with the channel at a location flow-wise between the main inlet and the main outlet.

13. A flow conditioning device, comprising:
a body portion having first and second ends and an interior surface defining a channel extending from the first end to the second end;
one or more flow conditioning elements disposed within the channel and being integrally formed with the interior surface, wherein each of the one or more flow conditioning elements is a respective flow straightening tube, a flow straightening vane, a hole array plate, a turning vane, a swirling vane or a helical ridge formed along a respective longitudinal segment of the interior surface; and
wherein the body portion and the one or more flow conditioning elements are formed by an additive manufacturing process.

14. The flow conditioning device of claim 13, wherein the body portion and the one or more flow conditioning elements are formed of the same material.

15. The flow conditioning device of claim 13, wherein the channel has a bend therein and each of the one or more flow conditioning elements is disposed proximate the bend in the form of a respective turning vane.

16. The flow conditioning device of claim 13, wherein the body portion has a generally non-straight tubular shape, and wherein the channel has a non-straight centerline.

17. The flow conditioning device of claim 13, wherein the channel defines a main inlet at the first end and a main outlet at the second end, the interior surface further defining an auxiliary channel within the body portion, the auxiliary channel having an auxiliary inlet at one end thereof separate from the main inlet and a mixing port at another end thereof, wherein the mixing port is disposed in fluid communication with the channel at a location flow-wise between the main inlet and the main outlet.

18. A flow conditioning apparatus for confined passage of a fluid therethrough, comprising:
a body portion having first and second ends and an interior surface defining a channel extending from the first end to the second end;
one or more flow conditioning elements disposed within the channel and being integrally formed with the interior surface, wherein each of the one or more flow conditioning elements is a respective flow straightening tube, a flow straightening vane, a hole array plate, a turning vane, a swirling vane or a helical ridge formed along a respective longitudinal segment of the interior surface; and
wherein the body portion and the one or more flow conditioning elements are formed of the same material by an additive manufacturing process.

19. The flow conditioning apparatus of claim 18, wherein the channel has a bend therein and each of the one or more flow conditioning elements is disposed proximate the bend in the form of a respective turning vane.

20. The flow conditioning apparatus of claim 18, wherein the channel defines a main inlet at the first end and a main outlet at the second end, the interior surface further defining an auxiliary channel within the body portion, the auxiliary channel having an auxiliary inlet at one end thereof separate from the main inlet and a mixing port at another end thereof, wherein the mixing port is disposed in fluid communication with the channel at a location flow-wise between the main inlet and the main outlet.
